(19) United States
(12) Patent Application Publication
(10) Pub. No.: US 2009/0183970 A1
(43) Pub. Date: Jul. 23, 2009

(54) Device for transferring a hollow body by means of a rotated drum, from a supply conveying system to a discharge conveying system

(76) Inventor: Dietmar Ramminger, Westerheim (DE)

Correspondence Address: PAULEY PETERSEN & ERICKSON, 2800 WEST HIGGINS ROAD, SUITE 365, HOFFMAN ESTATES, IL, 60169, US

(21) Appl. No.: 11/886,017

(22) PCT Filed: Mar. 9, 2006
(86) PCT No.: PCT/EP06/02175

§ 371 Date: Sep. 10, 2007

(30) Foreign Application Priority Data
Mar. 10, 2005 (DE) 10 2005 011 130.0

(51) Int. Cl. B65G 29/00; B65G 47/84

(52) U.S. Cl. 198/471.1

(57) ABSTRACT

A device for the transfer of hollow bodies, such as cans or tubes, from a supply conveying system or an incoming means of transport to a discharge conveying system or an outgoing means of transport with one rotary driven drum with transport trays for holding the hollow bodies which are provided on the drum swivably around tubes parallel to the drum axis and to which vacuum pressure can be applied, with the transport trays being positively guided along a radial cam to generate a non-uniform transport speed. According to this invention, the transport trays are shiftable an swivable tubes for supplying the vacuum pressure axially and individually movably on intermediate slides in curved paths of the drum, with the transport trays being in contact, on the swivable tubes via swivel levers rigidly connected with them, with at least two radial cams for adjustment to the speeds of the incoming and outgoing means of transport at the corresponding transfer points.

### BACKGROUND OF THE INVENTION

1. Field of the Invention

This invention relates to a device for the transfer of hollow bodies, such as cans or tubes, from an incoming to an outgoing transport.

2. Discussion of Related Art

A transfer device is known from German Patent Reference DE 195 40 158 C2. With this device, objects such as cans and the like, are transferred from a first transport to a second transport, with the speed and/or the positions of the objects relative to each other during the transfer having to be changed. With this known device, there is a transfer drum in which the cans are held in transport trays and by vacuum pressure, with the transport trays being swivel-mounted about swivel axes. At the transfer points, the transport trays are accelerated or, respectively, decelerated by cam control.

However, with this device, it is not possible to divide one single-line supplied transport line into multiple-line parallel transport lines or vice versa, from one multiple-line to one single-line transport line.

### SUMMARY OF THE INVENTION

It is one objective of this invention to provide a device for the transfer of hollow bodies which will enable, at the same time, their positional changes by shifting and also a compensation by speed adjustments at the transfer points.

This problem is solved by a transfer device having features discussed in this specification and in the claims, whereby a compensation/shifting drum is provided.

### BRIEF DESCRIPTION OF THE DRAWINGS

This invention is explained in detail, with reference to drawings, in view of an exemplary embodiment with a single-line incoming transport, a compensation/shifting drum which effects through shifting, a positional change of the supplied hollow bodies to two lines and, with a simultaneous speed adjustment, their transporting off by a double-line transport, wherein:

FIG. 1 shows a drum with an incoming and an outgoing transport, in a cross section;

FIG. 2 shows the drum according to FIG. 1 in a top view; and

FIG. 3 shows the kinematic connection of every second tray carrier guided by a radial cam.

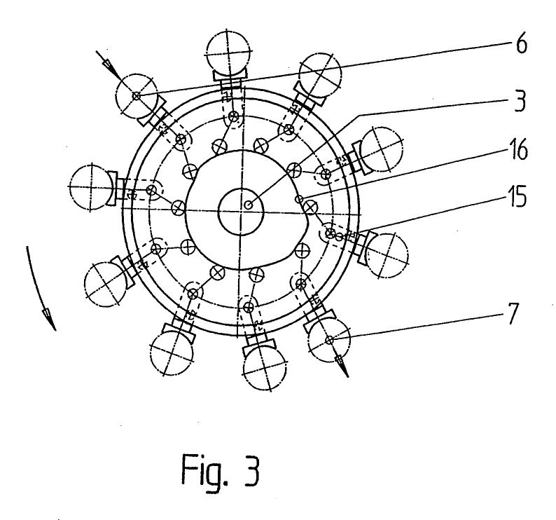

### DETAILED DESCRIPTION OF THE INVENTION

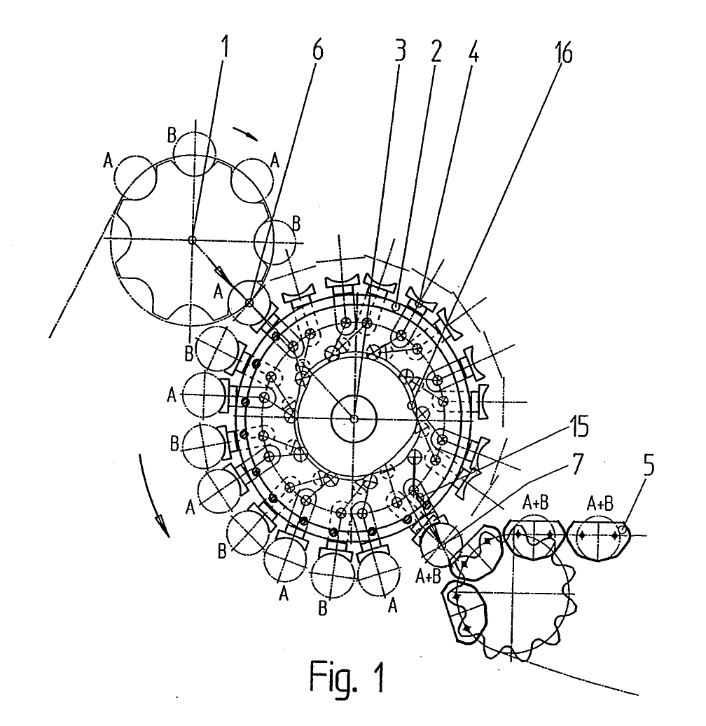

The device shown in FIG. 1 comprises an incoming single-line transport 1 with hollow bodies A and B and a rotary driven drum 2 with a central hollow axis 3. On the drum 2, the individually arriving hollow bodies A and B are accepted into transport trays 4 and transported further. During further transport, they are changed in their position so that all hollow bodies A or, respectively, B are transferred to a second transport 5 to two parallel lines arranged side-by-side.

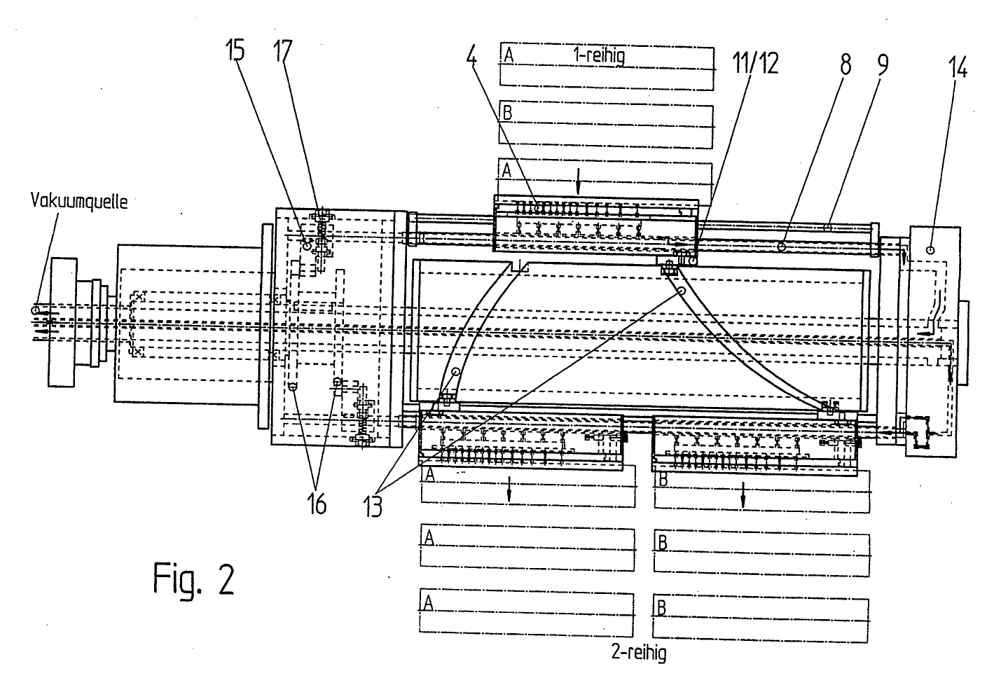

In the specified transfer points 6 or 7 respectively, the hollow bodies A and B are provided with the same transport speed as the first transport 1 or, respectively, the second transport 5. Thus, the drum 2 comprises suitable tubes 8 which can supply a vacuum. Spaced from tubes 8, one parallel axis 9 each is arranged for the transport trays 4. The transport trays 4 are replaceably arranged on intermediate slides 11. At the intermediate slides 11, projections 12 are introducible in curved paths 13 of the drum 2 for shifting the position of the hollow bodies in two parallel lines. If necessary, they can also be shifted into three or more parallel lines, not shown. The embodiment shows two curved paths 13, 13′ and that all hollow bodies A are transferred in a first line and all hollow bodies B are transferred in a parallel second line with the same axis, as shown in FIG. 2.

On one first or right side of the drum 2, the feed tubes 8 end in a control disk 14 through which the supply of vacuum to the transport trays 4 can be controlled to hold and fix the hollow bodies A, B during their transport around the drum 2.

On the opposite or left side of the drum 2, the swivable feed tubes 8 are in contact via swivel levers 15 with radial cams 16. This contact can be maintained by springs 17, for example. The radial cams 16 cause, by the transfer point 6, the corresponding transport tray 4 on the drum 2 to have the same speed as the first transport 1, and in the transfer point 7, the same speed as the second transport 5. Due to these speed adjustments effected via the radial cams 16, smooth and safe transfers will be enabled.

Preferably, the transport trays 4 are exchangeable, such as provided by plug-in connections on the drum 2, whereby, without any tool, a simple exchange of the transport trays 4 can enable an adjustment to different diameter sizes of the hollow bodies A, B.

With the control disk 14, the consumption of vacuum will be controlled and limited to the necessary minimum, with blowing out the transport trays 4, if necessary, possible in all transfer points 6, 7 for trouble-free transfers.

The device is also more economical overall because it only requires one drive for the continuous rotary movement of the drum 2 and, if necessary, of the transport 1, 5 as well, or, respectively, it can be coupled with an already existing drive (not shown) so that even the purchase costs are significantly more economical.

1-8. (canceled)

9. A device for transfer of hollow bodies (A, B), such as cans or tubes, from an incoming transport (1) to an outgoing transport (5) comprising a rotary driven drum (2) with transport trays (4) for holding the hollow bodies (A, B) which are arranged on the drum (2) swivably around tubes (8) which are parallel to a drum axis (3) and to which vacuum pressure can be applied, wherein the transport trays (4) are positively guided along a radial cam (16) to generate a non-uniform transport speed, and wherein the transport trays (4) are arranged on the swivable tubes (8) via swivel levers (15) rigidly connected with the swivable tubes (8) in contact with at least two radial cams (16) for adjustment to speeds of the incoming transport and the outgoing transport (1, 5) at corresponding transfer points (6, 7), the device comprising the transport trays (4) shiftable on the swivable tubes (8) axially and individually movably on intermediate slides (11) in curved paths (13) of the drum (2).

10. The device for the transfer of hollow bodies according to claim 9, wherein the incoming transport (1) is multiple-lined, and the outgoing transport (5) is single-lined.

11. The device for the transfer of hollow bodies according to claim 10, wherein axes (9) for the transport trays (4) on the tubes (8) are rigidly connected with the tubes (8).

12. The device for the transfer of hollow bodies according to claim 11, wherein at least one of the radial cams (16) and the control disks (14) for the vacuum supply are arranged on a side of the drum (2).

13. The device for the transfer of hollow bodies according to claim 12, wherein the radial cams (16) and the contacting swivel levels (15) are in a separate housing into which the swivable tubes (8) are sealingly guided.

14. The device for the transfer of hollow bodies according to claim 13, wherein the transport trays (4) are exchangeably provided on the intermediate slides (11).

15. The device for the transfer of hollow bodies according to claim 14, wherein in the transfer points (6, 7) compressed air is supplied for releasing the hollow bodies (A, B) to be transferred out of the transport trays (4).

16. The device for the transfer of hollow bodies according to claim 9, wherein at least one of the radial cams (16) and the control disks (14) for the vacuum supply are arranged on a side of the drum (2).

17. The device for the transfer of hollow bodies according to claim 16, wherein the radial cams (16) and the contacting swivel levels (15) are in a separate housing into which the swivable tubes (8) are sealingly guided.

18. The device for the transfer of hollow bodies according to claim 9, wherein the transport trays (4) are exchangeably provided on the intermediate slides (11).

19. The device for the transfer of hollow bodies according to claim 9, wherein in the transfer points (6, 7) compressed air is supplied for releasing the hollow bodies (A, B) to be transferred out of the transport trays (4).
